(19) United States
(12) Patent Application Publication
(10) Pub. No.: US 2019/0359354 A1
(43) Pub. Date: Nov. 28, 2019

(54) Deployable Wrapped Rib Assembly

(71) Applicant: OXFORD SPACE SYSTEMS LIMITED, Harwell Oxford Didcot (GB)

(72) Inventors: Yoshiro OGI, Didcot, Oxfordshire (GB); Juan REVELES, Longworth, Oxfordshire (GB); Vincent FRAUX, Didcot, Oxfordshire (GB); Ashley DOVE-JAY, Wallingford, Oxfordshire (GB)

(21) Appl. No.: 16/348,390

(22) PCT Filed: Nov. 8, 2017
(86) PCT No.: PCT/GB2017/053362

§ 371 Date: May 8, 2019

(30) Foreign Application Priority Data
Nov. 8, 2016 (GB) 1618844.3

(51) Int. Cl. B64G 1/22; H01Q 1/08; H01Q 1/28

(52) U.S. Cl. CPC B64G 1/222; B64G 1/443; H01Q 1/288; H01Q 1/085

(57) ABSTRACT

A deployable wrapped rib assembly is disclosed, comprising a hub, a plurality of ribs each being connected to the hub at a fixed angle such that each rib is inclined with respect to a perimeter of the hub, each one of the plurality of ribs being capable of being wrapped around the hub in a stowed configuration and configured to extend from the perimeter of the hub in a deployed configuration, and sheet material connected between the ribs. In a deployed configuration, the sheet material is held taut between the ribs. The ribs may have a lenticular cross-section, and/or may be attached to the hub at an angle with respect to the outer surface of the hub. A method of fabricating the deployable wrapped rib assembly is also disclosed.

### TECHNICAL FIELD

The present invention relates to deployable wrapped rib assemblies.

### BACKGROUND

Deployable antennas have been developed which use a wrapped rib architecture consisting of a central hub with a hold down and release mechanism (HDRM), a plurality of ribs extending from the hub, and a radio frequency (RF) reflector membrane attached to the ribs. In one such antenna, a plurality of ribs extend radially from the hub in the deployed configuration, and are connected to the hub via pivoted brackets which enable the ribs to be folded flat against the outer surface of the hub. In a stowed configuration, the ribs are piled and wrapped around the hub. The antenna is deployed by means of elastic energy stored in the ribs in the stowed configuration.

The invention is made in this context.

### SUMMARY OF THE INVENTION

According to a first aspect of the present invention, there is provided a deployable wrapped rib assembly comprising a hub, a plurality of ribs each connected to the hub at a fixed angle such that each rib is inclined with respect to a perimeter of the hub, each one of the plurality of ribs being wrapped around the hub in a stowed configuration and configured to extend from the perimeter of the hub in a deployed configuration, and sheet material connected between the ribs such that in a deployed configuration the sheet material is held taut between the ribs.

In some embodiments according to the first aspect, in the stowed configuration each one of the plurality of ribs is wrapped around the hub so as to have a first curvature in a region of the rib close to the point at which the rib is connected to the hub and a second curvature in a region of the rib further from the point at which the rib is connected to the hub, the first curvature being greater than the second curvature.

In some embodiments according to the first aspect, in the deployed configuration each one of the plurality of ribs is configured to lie substantially parallel to the radius of the hub at the point at which the rib is connected to the hub.

In some embodiments according to the first aspect, in the stowed configuration each of the plurality of ribs is at least partially flattened in cross-section thereby storing elastic energy for causing the wrapped rib assembly to automatically deploy when a restraining force on the plurality of ribs is released.

In some embodiments according to the first aspect, each of the plurality of ribs is hollow. For example, a hollow rib may have a lenticular cross-section. However, in other embodiments a different cross-sectional shape may be used.

In some embodiments according to the first aspect, the deployable wrapped rib assembly further comprises a plurality of cables arranged to hold the plurality of ribs under tension in the deployed configuration.

In some embodiments according to the first aspect, the deployable wrapped rib assembly further comprises retaining means for retaining the deployable wrapped rib assembly in the stowed configuration, wherein the retaining means can be released to allow the wrapped rib assembly to be automatically deployed by elastic energy stored in the ribs in the stowed configuration.

In some embodiments according to the first aspect, the deployable wrapped rib assembly is configured to form a primary reflector of an antenna in the deployed configuration.

In some embodiments according to the first aspect, the plurality of ribs are arranged to extend out of the plane of the hub in the deployed configuration, such that in the deployed configuration the sheet material adopts a non-planar form. For example, in the deployed configuration the sheet material may adopt a conical or concave form.

In some embodiments according to the first aspect, in the stowed configuration an initial bending segment of each rib is twisted such that the rib can start to wrap around the hub in the plane of the hub as the assembly is put into the stowed configuration.

In some embodiments according to the first aspect, a surface of the hub to which the plurality of ribs are attached is angled with respect to a central axis of the hub, such that each rib can start to wrap around the hub in the plane of the hub as the assembly is put into the stowed configuration.

According to a second aspect of the present invention, there is provided a method of fabricating a deployable wrapped rib assembly, the method comprising steps of: forming a plurality of ribs capable of being wrapped around a hub of the deployable wrapped rib assembly in a stowed configuration; connecting each one of the plurality of ribs to the hub at a fixed angle such that each rib is inclined with respect to a perimeter of the hub, and such that in a deployed configuration each one of the plurality of ribs is configured to extend from the perimeter of the hub.

In some embodiments according to the second aspect, each one of the plurality of ribs is connected to the hub at an angle of less than 90° to a radius of the hub at the point at which the rib is connected to the hub.

In some embodiments according to the second aspect, each one of the plurality of ribs is connected to the hub such that in the deployed configuration each one of the plurality of ribs is configured to lie substantially parallel to the radius of the hub at the point at which the rib is connected to the hub.

In some embodiments according to the second aspect, in the stowed configuration each of the plurality of ribs can be at least partially flattened in cross-section to store elastic energy for causing the wrapped rib assembly to automatically deploy when a restraining force on the plurality of ribs is released.

In some embodiments according to the second aspect, each of the plurality of ribs is formed to be hollow. For example, a hollow rib may be formed so as to have a lenticular cross-section. However, in other embodiments a different cross-sectional shape may be used.

In some embodiments according to the second aspect, the method further comprises a step of connecting a plurality of cables to the plurality of ribs such that the plurality of cables are arranged to hold the plurality of ribs under tension in the deployed configuration.

In some embodiments according to the second aspect, the deployable wrapped rib assembly is configured to form a primary reflector of an antenna in the deployed configuration.

In some embodiments according to the second aspect, the method further comprises a step of putting the deployable wrapped rib assembly into the stowed configuration by wrapping the ribs around the hub.

In some embodiments according to the second aspect, the plurality of ribs are arranged to extend out of the plane of the hub in the deployed configuration, such that in the deployed configuration the sheet material adopts a non-planar form, and wrapping the ribs around the hub comprises twisting an initial bending segment of each rib such that the rib can start to wrap around the hub in the plane of the hub as the assembly is put into the stowed configuration.

In some embodiments according to the second aspect, in the stowed configuration, each one of the plurality of ribs may be wrapped around the hub so as to have a first curvature in a region of the rib close to the point at which the rib is connected to the hub and a second curvature in a region of the rib further from the point at which the rib is connected to the hub, the first curvature being greater than the second curvature. The method may also comprise a further step of engaging retaining means for retaining the deployable wrapped rib assembly in the stowed configuration, wherein the retaining means can subsequently be released to allow the wrapped rib assembly to be automatically deployed by elastic energy stored in the ribs in the stowed configuration.

### BRIEF DESCRIPTION OF THE DRAWINGS

Embodiments of the present invention will now be described, by way of example only, with reference to the accompanying drawings, in which:

FIG. 1 illustrates a perspective view of a deployable wrapped rib assembly in the deployed configuration, according to an embodiment of the present invention;

FIG. 2 illustrates the deployable wrapped rib assembly of FIG. 1 in the stowed configuration, according to an embodiment of the present invention;

FIG. 3 illustrates a plan view of the deployable wrapped rib assembly of FIG. 1, according to an embodiment of the present invention;

FIG. 4 illustrates a plan view of a deployable wrapped rib assembly comprising pre-tensioned cables, according to an embodiment of the present invention;

FIG. 5 illustrates possible rib cross-sections, according to embodiments of the present invention;

FIG. 6 is a flowchart showing a method of fabricating and deploying a wrapped rib assembly, according to an embodiment of the present invention;

FIG. 7 illustrates examples of petal geometries for different rib deployment angles, according to embodiments of the present invention;

FIG. 8 illustrates a wrapped rib in the stowed configuration, according to an embodiment of the present invention;

FIG. 9 illustrates a deployable wrapped rib assembly in which the outer surface of the hub is angled with respect to the central axis of the hub, according to an embodiment of the present invention; and

FIG. 10 illustrates an attachment angle and a deployment angle for a rib attached to the hub surface at an inclined angle, according to an embodiment of the present invention.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the scope of the present invention. Accordingly, the drawings and description are to be regarded as illustrative in nature and not restrictive. Like reference numerals designate like elements throughout the specification.

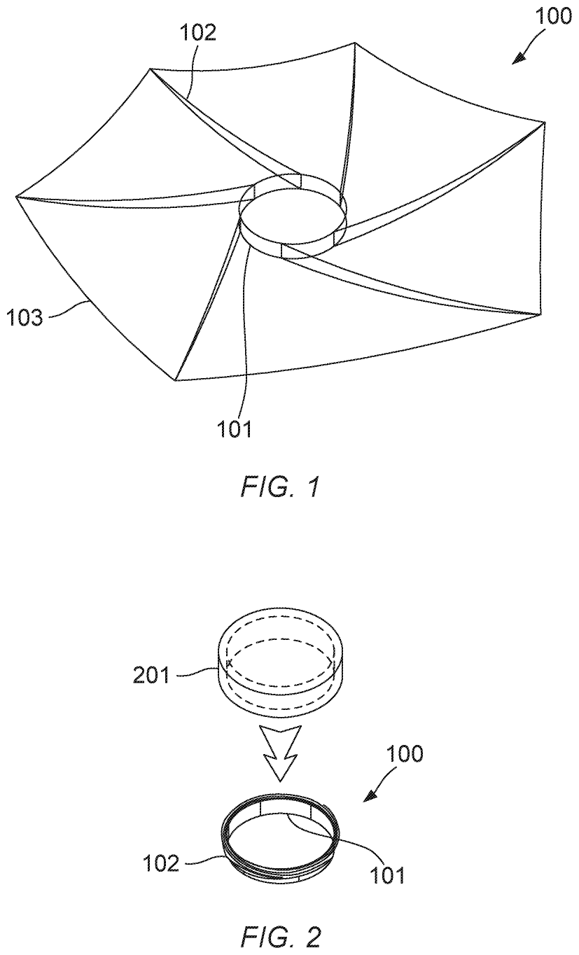

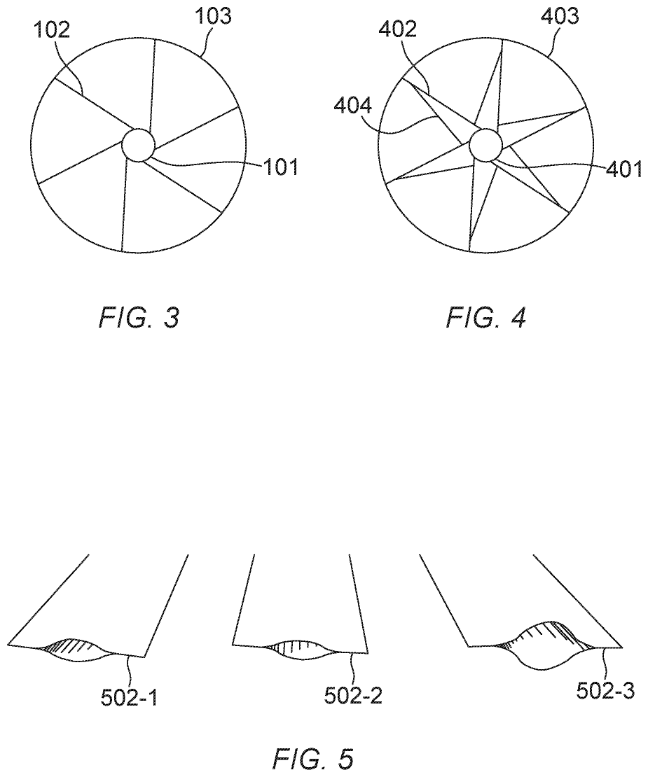

Referring now to FIGS. 1, 2 and 3, a deployable wrapped rib assembly is illustrated according to an embodiment of the present invention. FIG. 1 illustrates a perspective view of the deployable wrapped rib assembly in the deployed configuration, FIG. 2 illustrates the deployable wrapped rib assembly in the stowed configuration, and FIG. 3 illustrates a plan view of the deployable wrapped rib assembly in the deployed configuration.

In the present embodiment the deployable wrapped rib assembly 100 is configured to form a primary reflector of an antenna in the deployed configuration. However, in other embodiments the deployable wrapped rib assembly 100 may be configured for use in a different application. Examples of other applications in which the deployable wrapped rib assembly can be used include, but are not limited to: a solar light concentrator for photovoltaic power generation; a solar light reflector configured to act as a solar sail to accelerate a spacecraft; a sunshade; and a de-orbiting sail for increasing air-drag to de-orbit a spacecraft at the end of its useful life. In the present embodiment the deployable wrapped rib assembly 100 comprises six ribs 102, but in other embodiments a different number of ribs may be used according to the particular application and the sheet material with which the ribs are to be used.

As shown in FIG. 1, in the present embodiment the deployable wrapped rib assembly 100 comprises a hub 101, a plurality of ribs 102, and sheet material 103 connected between the ribs 102. The plurality of ribs 102 are configured to extend from a perimeter of the hub 101 in the deployed configuration. The plurality of ribs 102 are capable of being wrapped around the hub 101 in the stowed configuration, as shown in FIG. 2. For example, the ribs 102 may be formed of a flexible material such as a fibre reinforced composite material. In the present embodiment the hub 101 is circular, but in other embodiments different shapes of hubs may be used. For example, in another embodiment the perimeter of the hub may form a regular polygon, or may be an ellipse. An elliptical hub may be particularly suitable when the deployable wrapped rib assembly is used as the reflector in an off-set parabolic antenna.

The sheet material 103 is connected between the ribs 102 such that in the deployed configuration, the sheet material 103 is held taut between the ribs 102. The shape adopted by the sheet material 103 in the deployed configuration can be determined by choosing an appropriate profile for the ribs 102, and can vary according to the intended application. The area of material 103 between two ribs 102 may be referred to as a ‘petal’. In the present embodiment, the assembly 100 is configured to form the primary reflector of a Cassegrain antenna, and each rib 102 is configured to have a curved profile such that each petal adopts a concave shape when viewed from above in the orientation shown in FIG. 1. However, it will be readily appreciated that other geometries may be chosen for other applications.

In embodiments of the present invention, each one of a plurality of ribs in a deployable wrapped rib assembly is connected to the hub at a fixed angle such that each rib is inclined with respect to a perimeter of the hub. Here, the term “fixed angle” refers to the fact that the angle formed between the end of the rib connected to the hub and the perimeter of the hub remains the same in the stowed configuration and in the deployed configuration. The ribs may be attached to the hub at any angle with respect to the surface of the hub, which may be referred to as the attachment angle. The attachment angle may be defined in terms of the angle formed between the rib and the perimeter of the hub at the point at which the rib extends from the hub. Also, a deployment angle may be defined in terms of the angle formed between the rib in the deployed configuration and a radius passing through the point at which the rib extends from the hub, which may also be referred to as the attachment point. FIG. 10 illustrates the attachment angle (θ) and the deployment angle (φ) for a rib 1002 attached to a hub 1001 at an attachment angle greater than 0°, such that at the attachment point the rib 1002 is inclined with respect to the surface of the hub 1001.

In another embodiment the ribs may be attached at a different angle to that shown in FIG. 1, for example radially. In a radial configuration, each one of the plurality of ribs is configured to lie substantially parallel to the radius of the hub at the attachment point. In general, in other embodiments each rib 102 may be configured to be attached at any angle relative to the surface of the hub 101, up to 90° (i.e. perpendicular to the outer surface of the hub).

Depending on the embodiment, the sheet material 103 may be a single continuous sheet connected to all of the ribs, or may be made up of multiple separate sheets. For example, in some embodiments a separate sheet of material may be used for each petal, and/or each petal may comprise a plurality of separate pieces of sheet material. The sheet material 103 may be formed as a continuous sheet, for example a polymer or metallic film. Alternatively, in some embodiments the sheet material 103 may be discontinuous, that is, may include one or more openings. For example, the sheet material may comprise an open web or mesh.

As shown in FIG. 3, in the present embodiment each one of the plurality of ribs 102 is configured so as to lie in a plane when in the deployed configuration. To put it another way, each rib 102 is planar when in the deployed configuration. However, other rib shapes may be used in other embodiments. For example, the shape of the rib 102 in the deployed configuration can be determined by forming the rib 102 around an appropriately-shaped mould or mandrel.

In the present embodiment, each one of the plurality of ribs 102 is connected to the hub 101 at a fixed attachment angle, such that the angle formed between the end of the rib 102 that is connected to the hub 101 and the perimeter of the hub 101 remains the same in the stowed configuration and in the deployed configuration. The ribs 102 are stowed using elastic deformation. This approach simplifies the construction of the hub 101 and the ribs 102, in comparison to prior art designs which use hinges to connect the ribs to the hub.

In some embodiments of the present invention, the hub 101 may be configured for use with a suitable HDRM, which can also be referred to as a retaining means. An example of one such HDRM is illustrated in FIG. 2, and comprises a cap 201 configured to fit over and around the wrapped rib assembly 100 when in the stowed configuration to prevent the ribs 102 from unfolding. The cap 201 can subsequently be removed to allow the ribs 102 to unfurl freely of their own accord, using elastic energy stored within the wrapped ribs 102. For example, the cap 201 may be configured to form a secondary reflector of the antenna once the wrapped rib assembly 100 is deployed. It will be appreciated that this is just one example of a HDRM, and other suitable mechanisms may be used in other embodiments. For example, in another embodiment the HDRM may comprise an outer band wrapped around the ribs 102, or only around the far end of the outermost rib 102.

Referring now to FIG. 4 a plan view of a deployable wrapped rib assembly comprising pre-tensioned cables is illustrated, according to an embodiment of the present invention. Like the embodiment of FIGS. 1 to 3, in the present embodiment the deployable wrapped rib assembly comprises a hub 401, a plurality of ribs 402, and sheet material 403 connected between the ribs 402.

Also, in the present embodiment the deployable wrapped rib assembly further comprises a plurality of cables 404 arranged to hold the plurality of ribs 402 under compression in the deployed configuration. That is, in the deployed configuration each of the cables 404 is under tension and each of the ribs 402 is under compression. In the present embodiment, each one of the plurality of cables 404 is arranged to extend from a first point to a second point in the deployed configuration, the first point being a point along a first one of the plurality of ribs and the second point being a point along a second one of the plurality of ribs. In other embodiments, the first point may be a point on the hub or another fixed structure, rather than being a point along one of the other ribs. The second point is further from the hub than the first point in the deployed configuration, so that each cable 404 limits the displacement of the far end of the second one of the plurality of ribs in the deployed configuration, holding the second rib in compression along its longitudinal axis. This can be referred to as a ‘pre-stressed’ arrangement, and increases the overall stiffness of the wrapped rib assembly in the deployed configuration.

Referring now to FIG. 5 examples of possible rib cross-sections that can be used in embodiments of the present invention are schematically illustrated. In some embodiments of the present invention each rib has a lenticular (i.e. lens-shaped) cross-section, meaning that the thickness of the rib is greater at the centre than at the edges, when viewed in cross-section. In other embodiments a different cross-sectional shape may be used. The cross-section may be constant along the length of the rib, or may vary along the length of the rib. FIG. 5 illustrates three embodiments in which the ribs 502-1, 502-2, 502-3 have lenticular (i.e. lens-shaped) cross sections. The centre of the rib 502-1, 502-2, 502-3 can be hollow, as shown in FIG. 5, to reduce the weight of each rib 502-1, 502-2, 502-3. In the stowed configuration the lenticular part of the cross-section is partially flattened as the rib is wrapped around the hub, thereby storing elastic energy that can be used to automatically deploy the wrapped rib assembly. The stored elastic energy can cause the wrapped rib assembly to automatically deploy when a restraining force on the plurality of ribs is released, by urging the elastically-deformed ribs to straighten and return to their original un-deformed cross-sections in the deployed configuration.

In some embodiments the ribs may not be hollow, but may have an open shape in cross-section. For example, a rib may be formed as a thin sheet with a curved profile in cross-section. In some embodiments a rib may be formed to have a plurality of lobes when viewed in cross-section, each of which can be curved. A section of a rib which is curved in cross-section may deform elastically and flatten as the rib is wrapped around the hub, thereby storing elastic energy which can be used to automatically deploy the wrapped rib assembly, in a similar manner to that described above in relation to the embodiment of FIG. 5.

The cross-section can be configured to lend rigidity to the rib in the deployed configuration, helping to lock out the structure once it has been deployed. In the embodiments shown in FIG. 5, each side of the lenticular cross-section behaves as a tape-spring with opposing curvature. This gives the ribs 502-1, 502-2, 502-3 a self-locking property, so that in the extended configuration the rib tends to resist lateral deflection in either direction.

In embodiments of the present invention, the ribs may be formed from any suitable material. When selecting the material and cross-sectional shape of the rib, factors such as the required stiffness, strength, thermal distortion, and deployment repeatability can be taken into account. For example, a lenticular cross-section such as the ones shown in FIG. 5 may be formed using a composite material such as a carbon fibre-reinforced epoxy composite capable of being flattened and wrapped around the central hub, while storing sufficient energy to allow the assembly to self-deploy and providing the desired amount of stiffness after deployment.

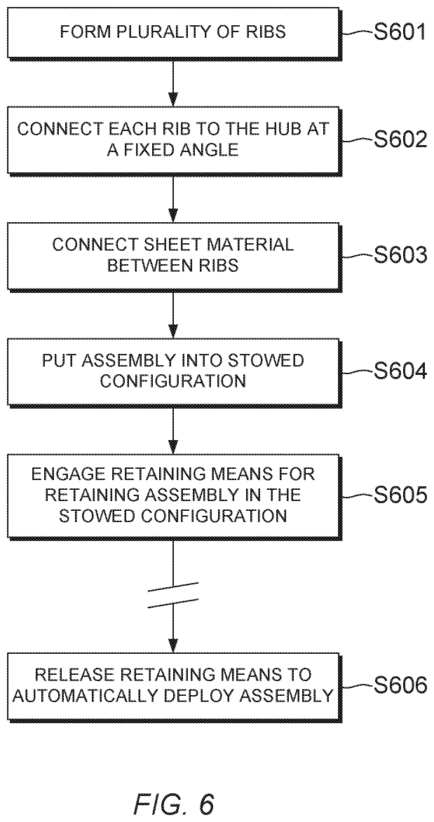

Referring now to FIG. 6, a method of fabricating and deploying a wrapped rib assembly is illustrated according to an embodiment of the present invention. The method can be used to fabricate and deploy any of the embodiments described herein.

First, in step S601 a plurality of ribs capable of being wrapped around a hub of the deployable wrapped rib assembly in a stowed configuration are formed. For example, as described above, the ribs may be formed by layering a composite material around a shaped mandrel.

Next, in step S602 the ribs are connected to the hub such that in the deployed configuration, each one of the plurality of ribs is configured to form an attachment angle of less than 90 degrees with the perimeter of the hub at the point at which the rib extends from the hub. As described above, the angle between the rib and the perimeter of the hub may vary between embodiments. In some embodiments, cables to support the structure in the deployed configuration, as shown in FIG. 4, may also be connected in step S602. The sheet material is then connected between the ribs in step S603, such that in the deployed configuration the sheet material is held taut between the ribs. In some embodiments, step S603 may include additional steps of checking and refining the geometry of the sheet material in the deployed configuration. This may be desirable when the final geometry is of particular importance, such as when the assembly is to be used as a reflector in an antenna.

In the present embodiment, the method further comprises a step of putting the deployable wrapped rib assembly into the stowed configuration by wrapping the ribs around the hub, in step S604. Then, in step S605 a HDRM is engaged to retain the deployable wrapped rib assembly in the stowed configuration. The retaining means can subsequently be released in step S606 to allow the wrapped rib assembly to be automatically deployed by elastic energy stored in the ribs in the stowed configuration.

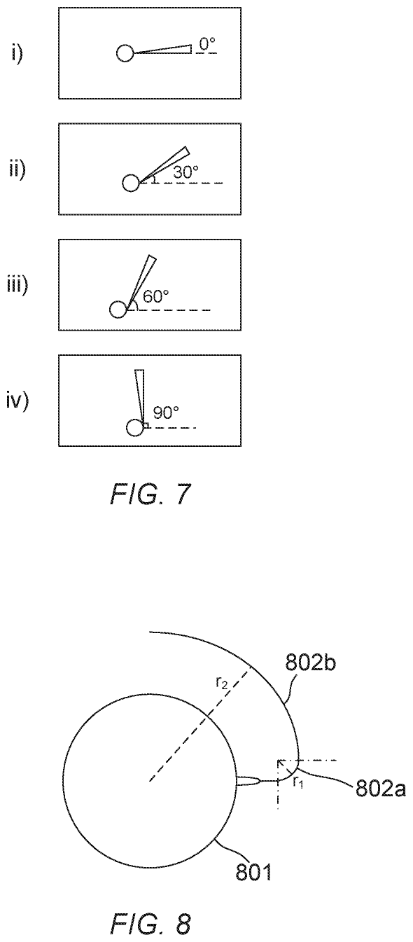

Referring now to FIG. 7, examples of petal geometries are illustrated for different deployment angles, according to embodiments of the present invention. Here, the petal geometry refers to the shape formed by the sheet material between two neighbouring ribs, when the deployable wrapped rib assembly is in the deployed configuration.

The diagrams in FIG. 7 illustrate one petal of a deployable wrapped rib assembly when viewed from above, in the orientation shown in FIGS. 3 and 4. The deployment angle between the ribs and the radius of the hub at the point where the rib is connected to the hub is varied from 0° in the top diagram to 90° in the bottom diagram. Embodiments are also illustrated in which intermediate deployment angles of 30° and 60° are used.

In the first embodiment (i) shown in FIG. 7, the rib is attached so as to have a deployment angle of 0° to the radius of the hub at the point where the rib is connected to the hub, i.e. at the attachment point. To put it another way, the rib in the first embodiment (i) is attached so as to form an attachment angle of 90°, since a circular hub is used. In the second embodiment (ii) the rib is attached at an angle of 30° to the radius, or to put it another way, at an attachment angle of 60°. In the third embodiment (iii) the rib is attached at an angle of 60° to the radius, equivalent to an attachment angle of 30°. Finally, in the fourth embodiment (iv) the rib is attached at an angle of 90° to the radius, equivalent to an attachment angle of 0°. It will be appreciated that these attachment angles are provided by way of an example, and in other embodiments a different attachment angle may be used. In embodiments of the invention in which the ribs are inclined with respect to the outer surface of the hub, the attachment angle may be 5°, 10°, 15°, 20°, 25°, 30°, 35°, 40°, 45°, 50°, 55°, 60°, 65°, 70°, 75°, 80°, 85°, or 90°, or may take an intermediate value between any of these angles. In some embodiments the ribs may be attached tangentially, that is, at an attachment angle of 0°.

Referring now to FIG. 8, a wrapped rib in the stowed configuration is illustrated according to an embodiment of the present invention. For clarity, only a single rib is illustrated in FIG. 8, but it will be understood that multiple ribs with similar geometries will be present in an actual embodiment.

As shown in FIG. 8, in the present embodiment the rib is attached radially. When the wrapped rib assembly is in the stowed configuration, the lenticular cross-section is flattened a short distance from the hub 801, and the rib is then bent through a relatively tight angle to wrap around the hub 801. A first part of the rib 802a in a region close to the point of attachment has a first radius of curvature r₁, and a second part of the rib 802b in a region further from the point of attachment has a second radius of curvature r₂, where r₂>r₁. This bending configuration enables the plurality of ribs to be wrapped tightly around the hub 801 in the stowed configuration, even though the ribs are attached to the hub 801 at a fixed angle, and is made possible by the use of a lenticular cross-section which gives the necessary flexibility. Also, because the ribs are attached at a fixed angle, the complexity of the hub 801 can be reduced in comparison to designs which require a hinged connection between hub and rib. The size of the assembly in the stowed configuration can be further reduced by decreasing the attachment angle.

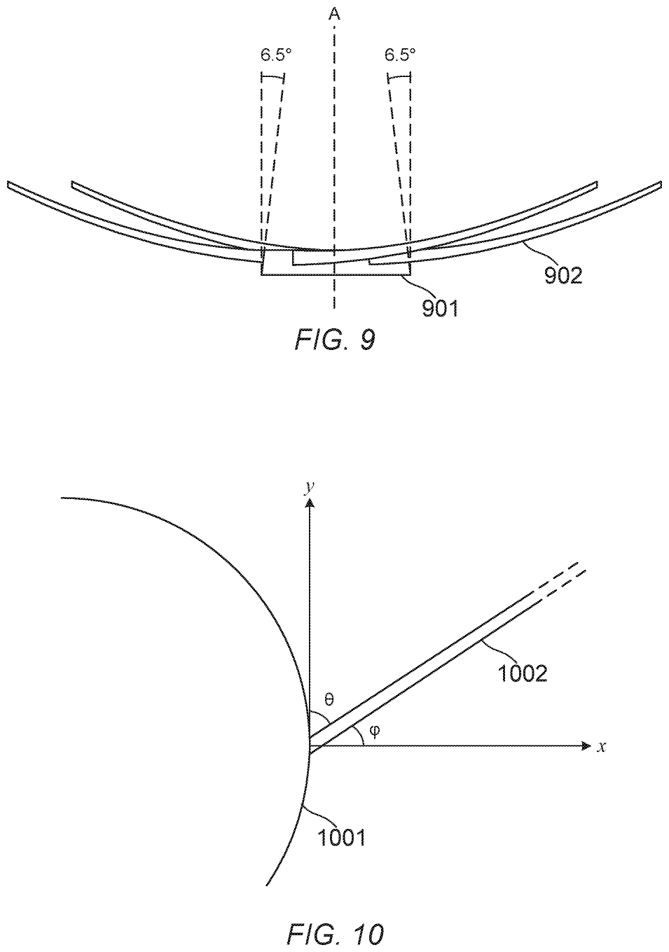

Referring now to FIG. 9, a deployable wrapped rib assembly in which the outer surface of the hub is angled with respect to the central axis of the hub is illustrated, according to an embodiment of the present invention. In this embodiment, the surface of the hub 901 to which the plurality of ribs 902 are attached is angled with respect to a central axis of the hub, labelled ‘A’ in FIG. 9. As a result, in the deployed configuration the sheet material adopts a non-planar form. In this embodiment, the sheet material adopts a concave form in the deployed configuration.

Alternatively, in some embodiments the plurality of ribs may be attached so as to be parallel to the central axis, rather than being inclined as shown in FIG. 9. In other words, in the orientation shown in FIG. 9, the ribs can be attached such that the surface of each rib is parallel to the vertical direction in the deployed configuration. In such embodiments, the assembly can be placed into the stowed configuration by applying a small torsion to the initial bending segment of each rib, such that the ribs are twisted to lie on the surface of a truncated cone as they are wrapped around the hub. Applying torsion to the initial bending segment can allow a rib which extends out of the plane of the hub in the deployed configuration, as in the embodiment shown in FIG. 9, to be twisted so as to lie in the plane of the hub as the rib is wrapped around the hub, thus minimising the overall height of the structure in the stowed configuration. In this way, the sheet material may still be arranged to adopt a non-planar form in the deployed configuration, for example by using curved ribs as shown in FIG. 9, without attaching the ribs at an inclined angle to the central axis.

Other arrangements are also possible. For example, in another embodiment the ribs 902 may be straight, such that the sheet material adopts a conical form in the deployed configuration. In the present embodiment the outer surface of the hub is inclined by 6.5° with respect to the central axis A, but in other embodiments a different angle may be selected depending on the desired configuration of the sheet material.

Whilst certain embodiments of the invention have been described herein with reference to the drawings, it will be understood that many variations and modifications will be possible without departing from the scope of the invention as defined in the accompanying claims.

1. A deployable wrapped rib assembly comprising:
a hub;
a plurality of ribs each connected to the hub at a fixed angle such that each rib is inclined with respect to a perimeter of the hub, each of the plurality of ribs being capable of being wrapped around the hub in a stowed configuration and configured to extend from the perimeter of the hub in a deployed configuration; and
sheet material connected between the ribs such that in a deployed configuration the sheet material is held taut between the ribs.

2. The deployable wrapped rib assembly of claim 1, wherein in the stowed configuration each one of the plurality of ribs is wrapped around the hub so as to have a first curvature in a region of the rib close to the point at which the rib is connected to the hub and a second curvature in a region of the rib further from the point at which the rib is connected to the hub, the first curvature being greater than the second curvature.

3. The deployable wrapped rib assembly of claim 1, wherein in the deployed configuration each one of the plurality of ribs is configured to lie substantially parallel to the radius of the hub at the point at which the rib is connected to the hub.

4. The deployable wrapped rib assembly of claim 1, wherein in the stowed configuration each of the plurality of ribs is at least partially flattened in cross-section thereby storing elastic energy for causing the wrapped rib assembly to automatically deploy when a restraining force on the plurality of ribs is released.

5. The deployable wrapped rib assembly of claim 1, wherein each of the plurality of ribs is hollow and has a lenticular cross-section.

6. The deployable wrapped rib assembly of claim 1, further comprising:
a plurality of cables arranged to hold the plurality of ribs under tension in the deployed configuration.

7. The deployable wrapped rib assembly of claim 1, further comprising:
retaining means for retaining the deployable wrapped rib assembly in the stowed configuration,
wherein the retaining means can be released to allow the wrapped rib assembly to be automatically deployed by elastic energy stored in the ribs in the stowed configuration.

8. The deployable wrapped rib assembly of claim 7, wherein the deployable wrapped rib assembly is in the stowed configuration, and the retaining means is engaged to retain the deployable wrapped rib assembly in the stowed configuration, and/or
wherein the deployable wrapped rib assembly is configured to form a primary reflector of an antenna in the deployed configuration, and/or
wherein the plurality of ribs are arranged to extend out of the plane of the hub in the deployed configuration, such that in the deployed configuration the sheet material adopts a non-planar form.

9. (canceled)

10. (canceled)

11. The deployable wrapped rib assembly of claim 10, wherein in the stowed configuration an initial bending segment of each rib is twisted such that the rib can start to wrap around the hub in the plane of the hub as the assembly is put into the stowed configuration, or
wherein a surface of the hub to which the plurality of ribs are attached is angled with respect to a central axis of the hub, such that each rib can start to wrap around the hub in the plane of the hub as the assembly is put into the stowed configuration.

12. (canceled)

13. The deployable wrapped rib assembly of claim 10, wherein in the deployed configuration the sheet material adopts a conical or concave form.

14. A method of fabricating a deployable wrapped rib assembly, the method comprising:
forming a plurality of ribs each capable of being wrapped around a hub of the deployable wrapped rib assembly in a stowed configuration;
connecting each one of the plurality of ribs to the hub at a fixed angle such that each rib is inclined with respect to a perimeter of the hub, and such that in a deployed configuration each one of the plurality of ribs is configured to extend from the perimeter of the hub; and
connecting sheet material between the ribs such that in a deployed configuration the sheet material is held taut between the ribs.

15. The method of claim 14, wherein each one of the plurality of ribs is connected to the hub such that in the deployed configuration each one of the plurality of ribs is configured to lie substantially parallel to the radius of the hub at the point at which the rib is connected to the hub.

16. The method of claim 14, wherein in the stowed configuration each of the plurality of ribs can be at least partially flattened in cross-section to store elastic energy for causing the wrapped rib assembly to automatically deploy when a restraining force on the plurality of ribs is released.

17. The method of claim 14, wherein each of the plurality of ribs is hollow, and is formed so as to have a lenticular cross-section.

18. The method of claim 14, further comprising:
connecting a plurality of cables to the plurality of ribs, such that the plurality of cables are arranged to hold the plurality of ribs under tension in the deployed configuration.

19. The method of claim 14, wherein the deployable wrapped rib assembly is configured to form a primary reflector of an antenna in the deployed configuration.

20. The method of claim 14, further comprising:
putting the deployable wrapped rib assembly into the stowed configuration by wrapping the ribs around the hub.

21. The method of claim 20, wherein the plurality of ribs are arranged to extend out of the plane of the hub in the deployed configuration, such that in the deployed configuration the sheet material adopts a non-planar form, and wrapping the ribs around the hub comprises twisting an initial bending segment of each rib such that the rib starts to wrap around the hub in the plane of the hub as the assembly is put into the stowed configuration.

22. The method of claim 20, wherein in the stowed configuration each one of the plurality of ribs is wrapped around the hub so as to have a first curvature in a region of the rib close to the point at which the rib is connected to the hub and a second curvature in a region of the rib further from the point at which the rib is connected to the hub, the first curvature being greater than the second curvature.

23. The method of claim 20, further comprising:
engaging retaining means for retaining the deployable wrapped rib assembly in the stowed configuration, wherein the retaining means can subsequently be released to allow the wrapped rib assembly to be automatically deployed by elastic energy stored in the ribs in the stowed configuration.
